(19) United States
(12) Patent Application Publication
(10) Pub. No.: US 2006/0085801 A1
(43) Pub. Date: Apr. 20, 2006

(54) Fastening mechanism for portable digital audio data player

(75) Inventors: Hoay-Lye Cheah, Penang (MY); Shih-Hsiung Weng, Taipei (TW)

Correspondence Address: EDWARDS & ANGELL, LLP, P.O. BOX 55874, BOSTON, MA, 02205, US

(73) Assignee: Inventec Multimedia & Telecom Corporation, Taipei (TW)

(21) Appl. No.: 11/204,556

(22) Filed: Aug. 15, 2005

(30) Foreign Application Priority Data
Oct. 14, 2004 (TW) 093216337

(51) Int. Cl. G11B 33/02; G11B 17/04; G11B 17/03

(52) U.S. Cl. 720/600

(57) ABSTRACT

A fastening mechanism for a portable digital audio player is proposed and adapted for connecting the body of a portable digital audio player to an external device or surface, the fastening mechanism including: a first positioning member installed on one side of the body of the portable audio player, a blocking member installed on one side of the first positioning member, a second positioning member installed on one side of the first positioning member apart from the blocking member, and a fixing base adapted for connecting with an external device having a third positioning member that corresponds to the first positioning member, and a fourth positioning member that corresponds to the second positioning member, thereby allowing the portable audio data player to be fastened to an external device/surface securely.

### BACKGROUND OF THE INVENTION

1. Field of the Invention

The present invention relates to fastening mechanisms for electronic products, and more particularly, to a fastening mechanism for portable audio data players.

2. Description of Related Art

The use of portable audio players capable of playing digitally encoded audio data has become commonplace. In particular, small handheld devices that can process digitally encoded audio data stored on solid state memory devices have become popular. Additionally, as demand has increased for higher data storage capacity in portable audio players, a generation of players utilizing miniaturized hard drives has been developed and is gaining popularity. Product manufacturers take great interest and spend much effort in developing electronic products that have high functionality and portability, such as cell phones, digital cameras, and portable digital audio players such as MP3 (MPEG Audio Layer 3) players that use compressed digital formats because these types of products are among the most favored by consumers.

While general portable audio players are compactly built with sizes small enough for carrying in the users' pockets, users often choose to carry accessories such as hanging instruments, leather covers, or clamping members to carry their portable audio players around for the convenience of using them anytime as desired. However, the aforementioned accessories for carrying the players around often undesirably cause inconveniences in practical use.

For instance, when a user uses a hanging instrument to carry an MP3 player around the neck, the hanging instrument might get intertwined with other hanging instruments carrying a cell phone or an enterprise identify card that the user carries at the same time, and it also increases the burden on the neck. Moreover, since it has become popular for a user to listen to an audio player and dance at the same time, not only might the hanging instrument and audio player carried in front of the user's chest collide with the body, but also the electromagnet waves generated from the player itself might interfere with other electronic products suspended from the user. Moreover, it might not be desirable to expose the user to the electromagnetic fields associated with an audio player at close proximity. As such, there exists several limitations and hidden pitfalls in the use of a hanging instrument for a user to carry a portable audio player around.

In the case of a user using a leather cover to carry a portable audio player that is fastened to the user's clothing, such as a belt or the user's wrist, inevitably the leather cover becomes cumbersome when the user dances or engages in exercise. Besides, when such an attachment scheme is used while driving, a user might pull the user's hands from the wheel while driving, posing a danger to the safety of the user. Also, using a leather cover still has the potential problem of electromagnetic fields endangering the users' health. As such, the alternative use of a leather cover causes inconveniences and safety concerns similar to those in the previous case of using a hanging instrument.

In another alternative, a user might use a clamping member to fasten a portable audio player to an article of clothing worn by the user, such as a belt, a pocket, or the lapel or collar of a garment. Similarly, the use of a clamping member has the same drawbacks as mentioned above, and it also easily leaves marks or stains from clamping on the user's clothing or even damages the clothing as a result. Also, this kind of clamping member is generally used to fasten to one side of a portable audio player and protrudes outside the surface of the portable audio player in a way that easily get entwined with other objects, and, in order to be removed or attached, a tool may be required in addition to physical effort, thereby limiting portability due to the inconvenience in assembly.

Therefore, there exists a need to develop a novel mechanism that can improve on the drawbacks of prior art techniques to thereby allow the users to safely and comfortably carry the portable audio players around at will.

### SUMMARY OF THE INVENTION

The present invention aims to eliminate the aforementioned drawbacks, and, as such, a primary objective of the present invention is to provide a fastening mechanism that is easy to affix onto a portable audio player by a user.

Another objective of the present invention is to provide a fastening mechanism that is easy to assemble to and dismantle from a portable audio player by a user.

Another objective of the present invention is to provide a fastening mechanism that is easy to carry around with a portable audio player.

In order to achieve the above and other objectives, the present invention provides a fastening mechanism for a portable audio player, the fastening mechanism being adapted to fasten the body of a portable audio player to an external device, the fastening mechanism at least comprising: a first positioning member installed on one side of the body, a blocking member installed on one side of the first positioning member, a second positioning member installed on one side of the first positioning member apart from the blocking member, and at least a fixing base adapted for connecting with an external device, wherein the fixing base is comprised of a third positioning member that corresponds to the first positioning member and a fourth positioning member that corresponds to the second positioning member, such that the first positioning can be connected by the third positioning member and the second positioning can be connected by the fourth positioning member, thereby allowing a portable audio player to be securely fastened to an external device.

In a preferred embodiment, the first positioning member is formed with an opening, and the blocking member can either be a rectangular bump or a rib stripe, wherein a positioning surface is adapted to be blocked by the blocking member; whereas the second positioning member is a hemispheric flange, a bump, or a slanted structure; and the fourth positioning member is comprised of a positioning fillister corresponding to the second positioning member. The fixing base is made of a soft plastic or magnetic material, wherein the fixing base can be further comprised of a fifth positioning member adapted for connecting with an external device. Preferably, the fifth positioning member can be a suction cup or a magnet such that the portable audio player can be easily fastened to any available external device/surface as desired, and even if a user is driving a car, dancing, or exercising, the portable audio player can still be easily fastened to an available external device such as the body of a car or a surface of a wall without the necessity of using tools for assembly.

Accordingly, the present invention offers advantages over the prior art techniques in that it can overcome the drawbacks of getting intertwined with hanging instruments worn by a user, burdening the user's neck with additional weight, exposing devices to electromagnetic interference, endangering the user's health due to close proximity of the user's body to electromagnetic fields, damaging the user's clothing, as well as the inconveniences in use, assembly, and disassembly.

### BRIEF DESCRIPTION OF DRAWINGS

The fastening mechanism of the present invention can be fully understood by reading the following detailed description of the preferred embodiments, with reference made to the accompanying drawings, wherein:

FIG. 1A is a sectional view of a portable audio player;

FIG. 1B is a partially enlarged view of FIG. 1A;

FIG. 1C is a partial schematic view of FIG. 1A;

FIG. 2A is a schematic sectional view of a fixing base according to the present invention;

FIG. 2B is a schematic view of the fixing base in one embodiment;

FIG. 3A is a schematic view showing the state before the body depicted in FIG. 1A is connected with the fixing base depicted in FIG. 2A;

FIG. 3B is a schematic view showing the state after the body depicted in FIG. 1A is connected with the fixing base depicted in FIG. 2A;

FIG. 4A is a sectional view of FIG. 3B; and

FIGS. 4B and 4C are partially enlarged views of FIG. 4A showing schematic views observed from both sides of FIG. 4A respectively.

### DETAILED DESCRIPTION OF PREFERRED EMBODIMENT

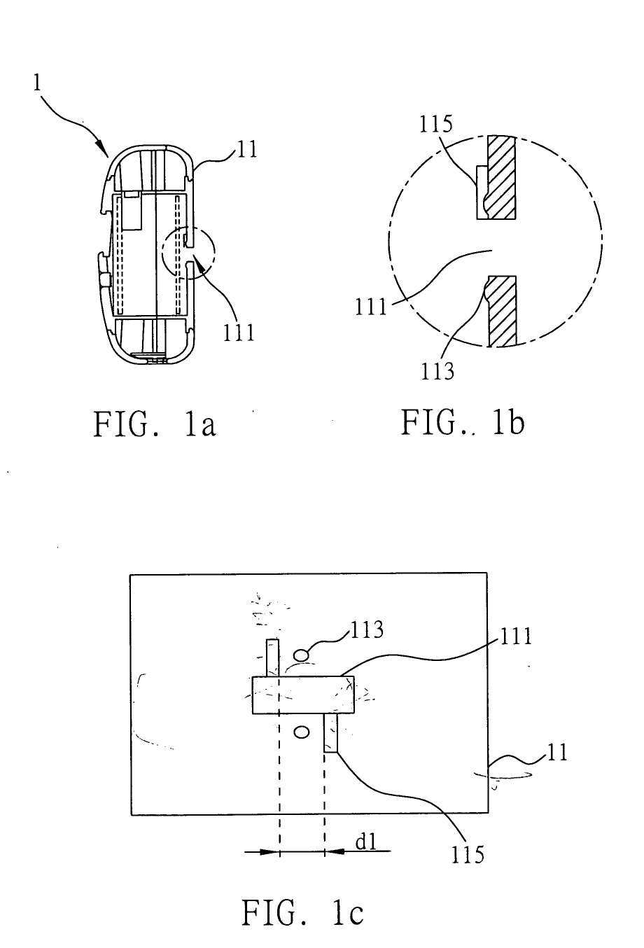

FIGS. 1A through 4C are schematic diagrams drawn according to a preferred embodiment of the fastening mechanism for a portable audio player of the present invention. The fastening mechanism for a portable audio player of the present invention is adapted to fasten the body 11 of a portable audio player 1 to an external device (not shown), the fastening mechanism at least comprising a first positioning member 111 installed in the body 11, a blocking member 115 installed at or near the edge of the first positioning member 111, a second positioning member 113 installed near one side of the first positioning member 111 apart from the blocking member 115, and a fixing base 21 adapted for connecting with an external device. While in this embodiment the digital format MP3 (MPEG Audio Layer 3) is exemplified for the portable audio player, note that the present invention can be applied to other kinds of portable audio players and other kinds of electronic products such as cell phones, digital cameras, and so on. Since the foregoing electronic products are known prior art techniques that have similar structures, the drawings accompanied herein only show the parts and structures that are directly related to the present invention for clarity and brevity.

As shown in FIG. 1A, one side of the body 11 is comprised of a first positioning member 111, the first positioning member 111 being an opening or other equivalents. The body is also comprised of at least a second positioning member 113, and a blocking member 115. As shown in FIG. 1B, the second positioning member 113 can be a hemispheric flange, a bump, or other equivalents. In this embodiment, the second positioning member 113 is installed on the inward side of the body and located at an edge of the opening of the first positioning member 111. The blocking member 115 is also installed on the inward side of the body near the first positioning member 111, the shape of its profile being a rectangular bump. Note that the blocking member 115 can also be a rib stripe or other equivalents and is not limited to that exemplified in the embodiment.

As shown in FIG. 1C, the first positioning member 111 is installed more or less in a center part of the body 11, wherein the two opposite edges of the first positioning member 111 are each respectively installed with a blocking member 115 thereon, the blocking members basically diagonally disposed, while a pair of second positioning members 113 is installed near the same two edges of the first positioning member 111 and spaced apart from the blocking members 115. To clearly illustrate and distinguish the structures of the first positioning member 111, the second positioning members 113, and the blocking members 115 of the body 11, the inner structure of the body 11 is not shown but only the related configurations.

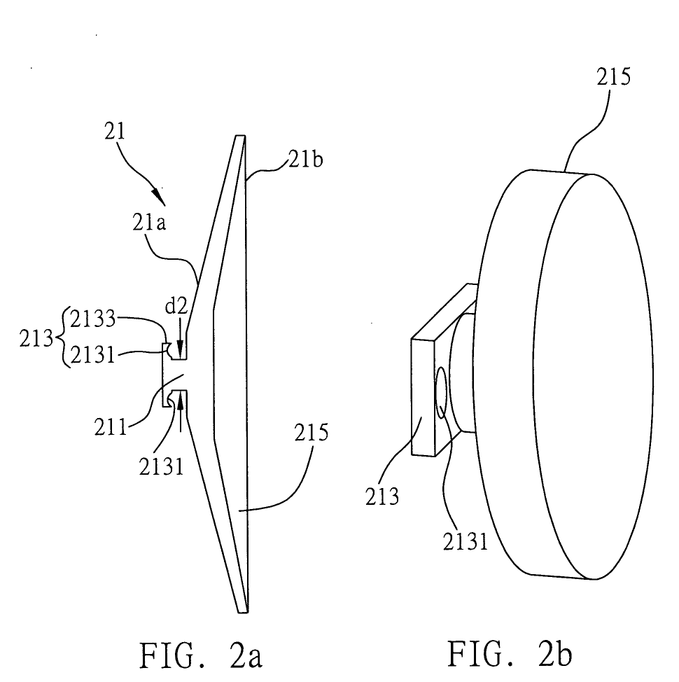

As shown in FIG. 2A, the fixing base 21 is comprised of a first surface 21a and a second surface 21b corresponding to the first surface 21a, wherein the first surface 21a is comprised of a third positioning member 211 corresponding to the first positioning member 111 and a fourth positioning member 213 corresponding to the second positioning member 113. The third positioning member 211 protrudes from the first surface 21a, and the shape and size of the third positioning member 211 correspond to the first positioning member 111, and, as illustrated in FIG. 1C and FIG. 2A, the length of the opening d1 between the blocking members 115 of the first positioning member 111 is equal to the length d2 of the third positioning member 211. The fourth positioning member 213 is comprised of a positioning fillister 2131 having a shape and size corresponding to the second positioning member 113 and a positioning surface 2133 that can be blocked by the blocking member 115, wherein the positioning fillister 2131 can be an opening or other equivalents, and the width of the positioning surface 2133 can be larger than the height of the blocking member 115, but is not limited to that described herein. The second surface 21b of the fixing base 21 is further comprised of a fifth positioning member 215 adapted for connecting with an external device, the details of which will be described later.

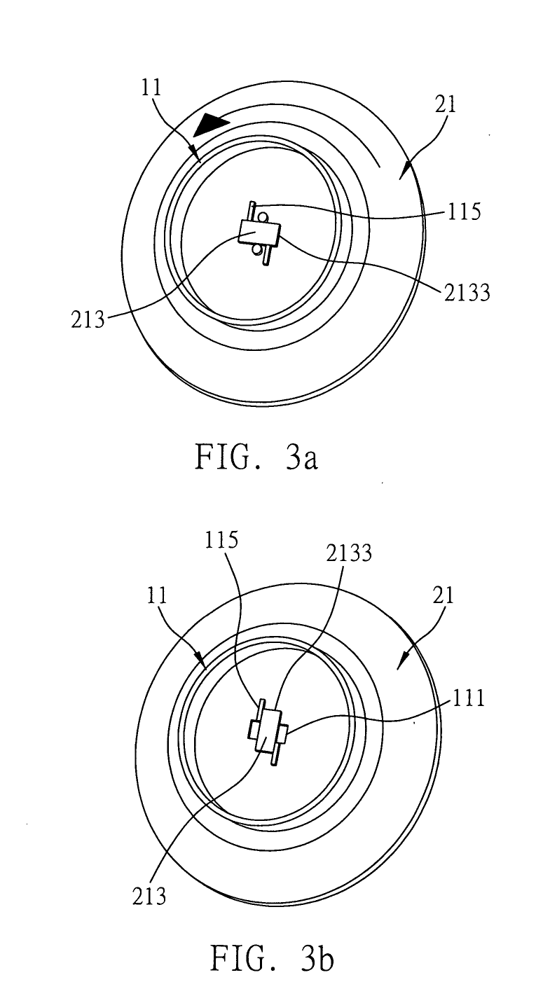

When the fixing base 21 is assembled onto the body 11, as illustrated in FIG. 3A, the third positioning member 211 passes through the first positioning member 111 such that the positioning surface 2133 of the fourth positioning member 213 can be blocked by a shorter side of the blocking member 115, whereas when the fourth positioning member 213 of the fixing base 21 rotates in an anti-clockwise direction, as shown in FIG. 3B, the fourth positioning member 213 is blocked by a longer side of the blocking member 115.

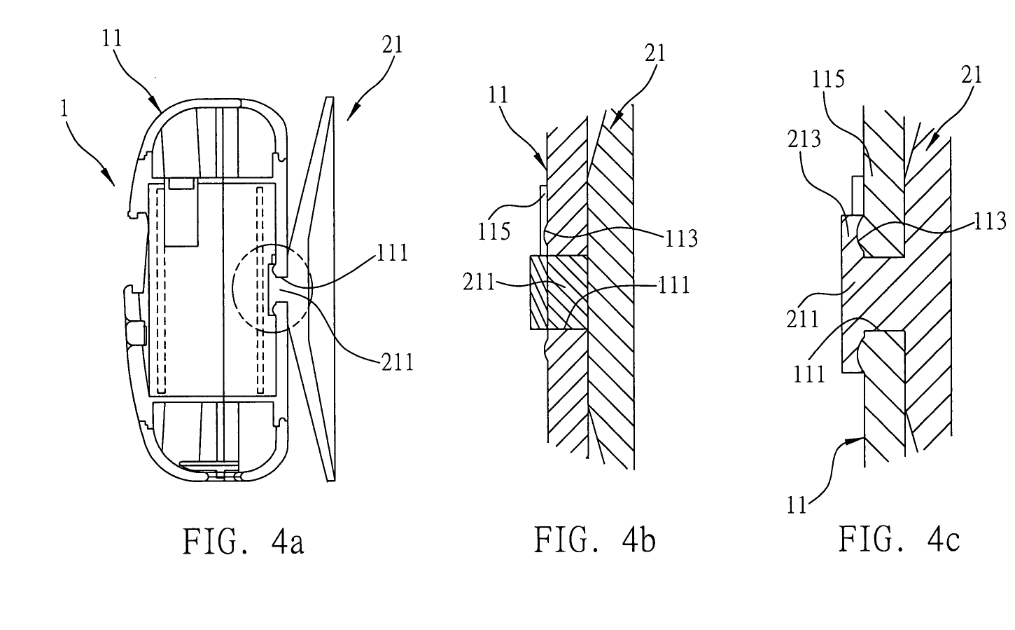

As shown in FIG. 4A, the fixing base 21 is connected with the body 11, and as shown in FIGS. 4B and 4C, the third positioning member 211 corresponds to the first positioning member 111 and the fourth positioning member 213 corresponds to the second positioning member 113, one side of the fourth positioning member 213 being blocked by the blocking member 115 so as to prevent the fixing base 21 from separating from the body 11, wherein the fourth positioning member 213 and the second positioning member 113 are structurally matched in indented and protruding shapes having angled surfaces for easily assembling or separating the fixing base 21 from the body 11; while in another embodiment, the fourth positioning member 213 and the second positioning member 113 can be a plane surface or a raised structure in order to reinforce the connection.

Accordingly, the fifth positioning member 215 of the fixing base 21 can then be used to connect with an external device to thereby fasten the portable audio player 1 to an external device, wherein the fixing base 21 can be made of a soft plastic material, thereby making the fifth positioning member 215 a sucker in a trumpet shape so as to fasten the fixing base 21 to the external device by the suction force.

Note that the structure and the material of the fixing base 21 are not limited to those described above. In other embodiments, as shown in FIG. 2B, the fifth positioning member 215 of the fixing base 21 can be an element made of a magnetic material such as a magnet, so as to fasten the fixing base 21 as well as the body 11 to an external device by the attractive force of a magnet that the fixing base 21 is made of, wherein the entire structure of the fixing base 21 can be made of a magnetic material such that the fixing base 21 can easily fasten the portable audio player 1 to the external device and also easily detach the portable audio player 1 from the external device.

In other words, in various embodiments, the structure and the material of the fixing base 21 and the fifth positioning member 215 can have variations depending on the implementations and requirements and are not restricted to those described herein. Also, although the fastening mechanism is respectively comprised of two positioning fillisters 2131, two fourth positioning members 213, and two corresponding blocking members 115, note that the forming positions and the number of the foregoing structures can have variations as long as a secure connection can be established so as to prevent the fourth positioning members 213 from detaching from the fastening position due to normal forces in usage.

When the fixing base 21 is separated from the body 11 in a clockwise direction, the positioning fillister 2131 and the positioning surface 2133 of the fourth positioning member 213 become free from the second positioning member 113 of the body 11 such that the third positioning member 211 can be taken out from the first positioning member 111, thereby detaching the portable audio player 1 from the fixing base 21.

With the provision of the fastening mechanism of the present invention, electronic products such as a portable audio player as exemplified above can be securely fastened to an external device, such as the body of a vehicle, a surface of a wall, a partition of an office, and so forth. As it is not necessary to use tools for assembling or disassembling the fixing base, a user can easily and rapidly assemble and disassemble the fixing base, providing for convenient usage as a result. Moreover, users may chose different structures of fixing bases made of different materials so as to securely fasten electronic players onto different external devices or surfaces, such that the electronic players can be used in different environments. Meanwhile, the health risk due to electromagnetic field exposure as occurs in prior art techniques can be significantly reduced.

Also note that the shape of the fixing base is not limited to a round one so long as it can connect with the body of the portable audio player and fasten to an external device securely; and the shape of the blocking member is not limited to a rectangular one but can also be formed in a wavy shape or even an irregular shape so long as it can provide the blocking effect as required; also, the second positioning member can be a fillister and the fourth positioning member a bump or a flange such that they can correspondingly match one another.

The aforementioned are only exemplary preferred embodiments of the present invention. The scope of the claims as stated below should be accorded the broadest interpretation so as to encompass various modifications and similar arrangements made to the herein described invention that fall within the spirit of the basic principles and technology of the present invention.

What is claimed is:

1. A fastening mechanism for a portable digital audio player, adapted for connecting a body of a portable digital audio player to an external device or surface, the fastening mechanism at least comprising:
a first positioning member installed on one side of the body;
a blocking member installed at or near one edge of the first positioning member;
a second positioning member installed near one side of the first positioning member apart from the blocking member; and
a fixing base for connecting with an external device and having a third positioning member that corresponds to the first positioning member and a fourth positioning member that corresponds to the second positioning member.

2. The fastening mechanism for a portable digital audio player of claim 1, wherein the first positioning member is formed with an opening.

3. The fastening mechanism for a portable digital audio player of claim 1, wherein the blocking member can be a rectangular flange or a rib stripe.

4. The fastening mechanism for a portable digital audio player of claim 1, wherein the second positioning member can be a hemispheric flange or a bump.

5. The fastening mechanism for a portable digital audio player of claim 1, wherein the second positioning member is a slanted structure.

6. The fastening mechanism for a portable digital audio player of claim 1, wherein the fixing base is a structure made of a soft plastic material.

7. The fastening mechanism for a portable digital audio player of claim 1, wherein the fixing base is a structure made of a magnetic material.

8. The fastening mechanism for a portable digital audio player of claim 1, wherein the fourth positioning member is comprised of a positioning fillister that corresponds to the second positioning member, and a positioning surface that can be blocked by the blocking member.

9. The fastening mechanism for a portable digital audio player of claim 1, wherein the fixing base is further comprised of a fifth positioning member adapted for connecting with an external device.

10. The fastening mechanism for a portable digital audio player of claim 1, wherein the fifth positioning member can be a suction cup or a magnet.
